(19) United States
(12) Patent Application Publication
(10) Pub. No.: US 2018/0211201 A1
(43) Pub. Date: Jul. 26, 2018

(54) SYSTEMS AND METHODS FOR OPTIMIZING OUTBOUND SHIPPING CAPACITY

(71) Applicant: WAL-MART STORES, INC., Bentonville, AR (US)

(72) Inventors: Amritayan Nayak, Sunnyvale, CA (US); Hem Singh, San Francisco, CA (US); Rajiv Kumar Jain, Fremont, CA (US); Sarabjeet Singh, San Francisco, CA (US)

(73) Assignee: WAL-MART STORES, INC., Bentonville, AR (US)

(21) Appl. No.: 15/414,296

(22) Filed: Jan. 24, 2017

(51) Int. Cl. G06Q 10/08; G06Q 10/06; G06Q 30/06

(52) U.S. Cl. CPC G06Q 10/083; G06Q 30/0635; G06Q 10/06314

(57) ABSTRACT

Systems and methods including one or more processing modules and one or more non-transitory storage modules storing computing instructions configured to run on the one or more processing modules and perform acts of receiving a high-priority first order, receiving a low-priority second order, adding an elastic shipping buffer to the low-priority second order to (1) prevent the low-priority second order from being shipped from the fulfillment center before the high-priority first order and also (2) prevent the low-priority second order from being delivered at a final destination after a service level agreement delivery date, and transmitting instructions to a shipping system to ship the high-priority first order from the fulfillment center before shipping the low-priority second order.

### TECHNICAL FIELD

This disclosure relates generally to systems and methods for optimizing outbound shipping capacity.

### BACKGROUND

Customers purchasing products from an online retailer are often able to choose different shipping speeds for their orders as part of a service level agreement (SLA) with the online retailer. For example, customers often can choose between 1-day shipping, 2-day shipping, and/or 3 to 5-day shipping. Sometimes new orders that include a SLA with 1-day shipping can be received by a retailer after an order that includes a SLA with 3 to 5-day shipping is received, while also requiring delivery before the order that includes the SLA with 3 to 5-day shipping. As a result, online retailers sometimes have difficulty meeting the SLA requirements of 1-day, 2-day, and/or 3-day shipping.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 5;

FIG. 2 illustrates a representative block diagram of an example of the elements included in the circuit boards inside a chassis of the computer system of FIG. 1;

FIG. 3 illustrates a representative block diagram of a system, according to an embodiment;

FIGS. 4A-E are flowcharts for a method, according to certain embodiments; and

FIG. 5 illustrates a representative block diagram of a portion of the system of FIG. 3, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value.

In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processing modules and one or more non-transitory storage modules storing computing instructions configured to run on the one or more processing modules. The one or more storage modules can be configured to run on the one or more processing modules and perform an act of receiving one or more first orders. Each order of the one or more first orders can comprise (1) one or more first products for shipping from a fulfillment center, (2) a final first destination for delivery of the one or more first products of the one or more first orders, and (3) a first service level agreement (SLA) that specifies a first date by which the one or more first products will be delivered at the final first destination. The one or more storage modules can be further configured to run on the one or more processing modules and perform an act of receiving one or more second orders. Each order of the one or more second orders can comprise (1) one or more second products for shipping from the fulfillment center, (2) a final second destination for delivery of the one or more second products of the one or more second orders, and (3) a second SLA that specifies a second date by which the one or more second products will be delivered at the final second destination. The one or more storage modules can be further configured to run on the one or more processing modules and perform an act of determining that the second date of the one or more second orders occurs after the first date of the one or more first orders. The one or more storage modules can be further configured to run on the one or more processing modules and perform an act of adding an elastic shipping buffer to the one or more second orders to (1) prevent the one or more second orders from being shipped from the fulfillment center before the one or more first orders and also (2) prevent the one or more second orders from being delivered at the final second destination after the second date of the second SLA. The one or more storage modules can be further configured to run on the one or more processing modules and perform an act of transmitting instructions to a shipping system to ship the one or more first products of the one or more first orders from the fulfillment center before shipping the one or more second products of the one or more second orders from the fulfillment center according to the elastic shipping buffer.

Various embodiments include a method. The method can include receiving one or more first orders. Each order of the one or more first orders can comprise (1) one or more first products for shipping from a fulfillment center, (2) a final first destination for delivery of the one or more first products of the one or more first orders, and (3) a first SLA that specifies a first date by which the one or more first products will be delivered at the final first destination. The method also can include receiving one or more second orders. Each order of the one or more second orders can comprise (1) one or more second products for shipping from the fulfillment center, (2) a final second destination for delivery of the one or more second products of the one or more second orders, and (3) a second SLA that specifies a second date by which the one or more second products will be delivered at the final second destination. The method also can include determining that the second date of the one or more second orders occurs after the first date of the one or more first orders. The method also can include adding an elastic shipping buffer to the one or more second orders to (1) prevent the one or more second orders from being shipped from the fulfillment center before the one or more first orders and also (2) prevent the one or more second orders from being delivered at the final second destination after the second date of the second SLA. The method also can include transmitting instructions to a shipping system to ship the one or more first products of the one or more first orders from the fulfillment center before shipping the one or more second products of the one or more second orders from the fulfillment center according to the elastic shipping buffer.

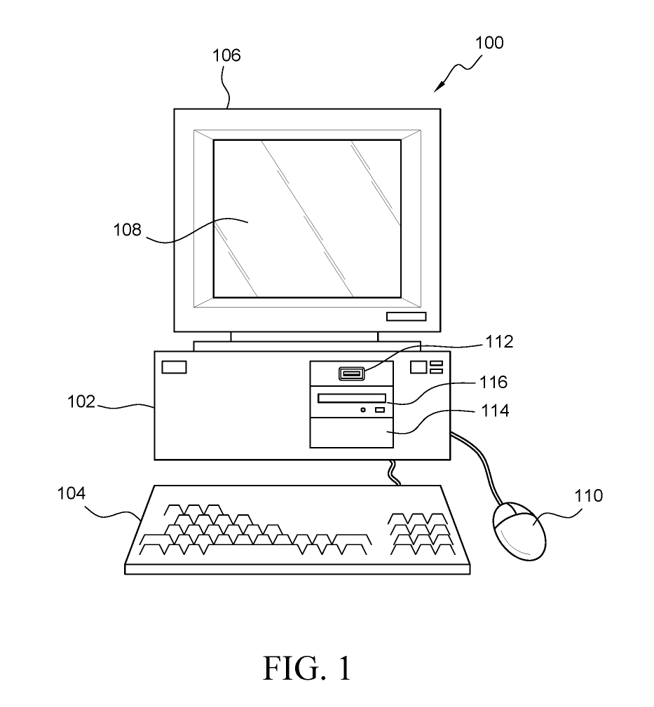

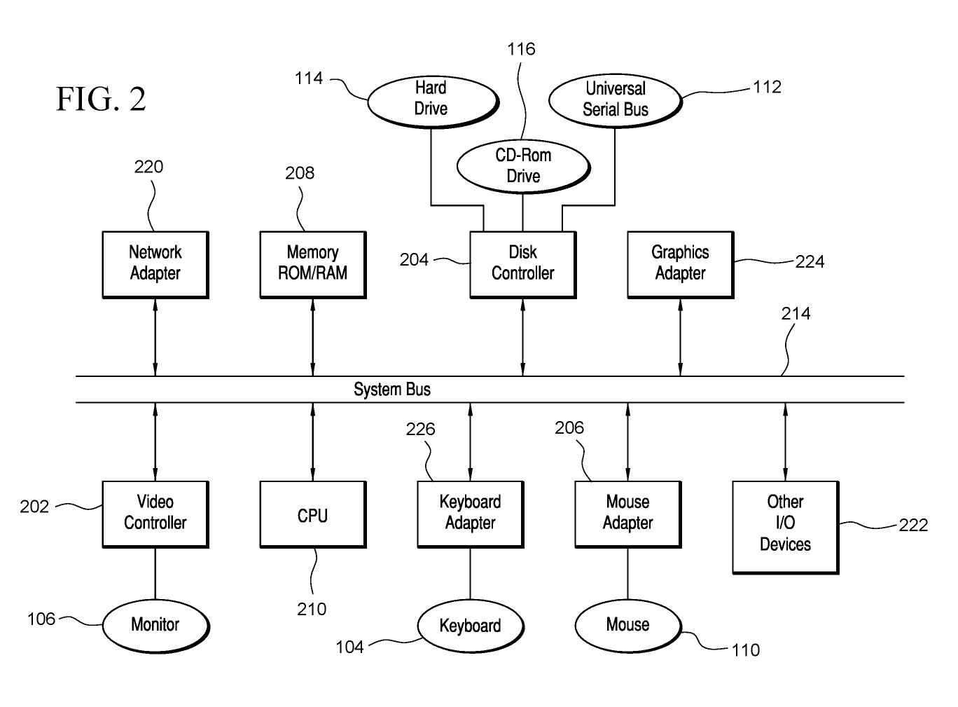

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, read only memory (ROM) and/or (ii) non-volatile (e.g., non-transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1-2), hard drive 114 (FIGS. 1-2), a CD-ROM and/or DVD for use with CD-ROM and/or DVD drive 116 (FIGS. 1-2), a floppy disk for use with a floppy disk drive (not shown), an optical disc (not shown), a magneto-optical disc (now shown), magnetic tape (not shown), etc. Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

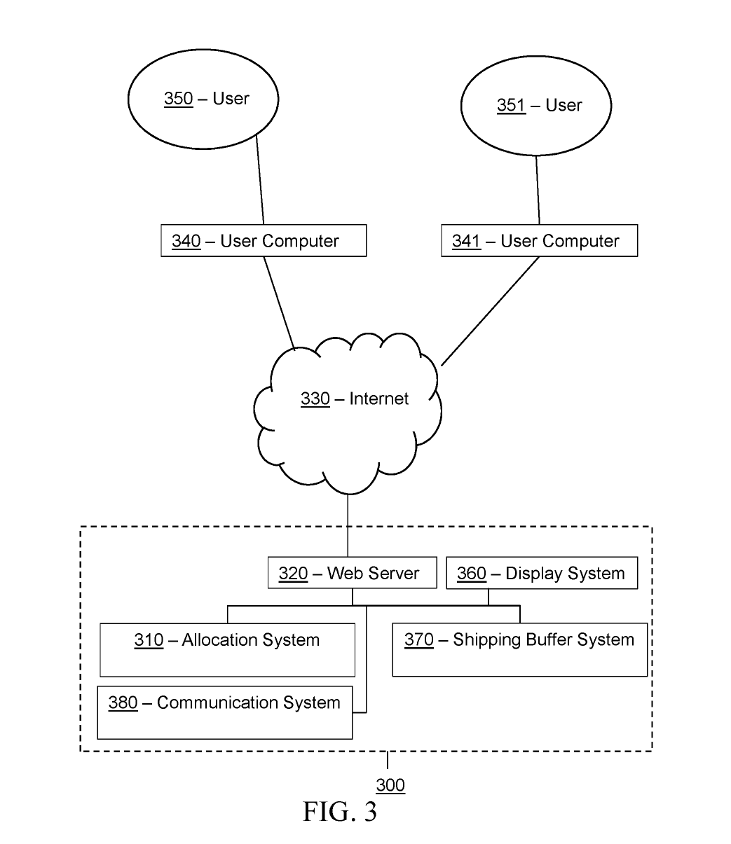

Turning ahead in the drawings, FIG. 3 illustrates a block diagram of a system 300 that can be employed for improving shipping capacity, as described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include an allocation system 310, a web server 320, a display system 360, a shipping buffer system 370, and/or a communication system 380. Allocation system 310, web server 320, display system 360, shipping buffer system 370, and/or communication system 380 can each be a computer system, such as computer system 100 (FIG. 1), as described above, and can each be a single computer, a single server, or a cluster or collection of computers or servers, or a cloud of computers or servers. In another embodiment, a single computer system can host each of two or more of allocation system 310, web server 320, display system 360, shipping buffer system 370, and/or communication system 380. Additional details regarding parameter allocation system 310, web server 320, display system 360, shipping buffer system 370, and/or communication system 380 are described herein.

In many embodiments, system 300 also can comprise user computers 340, 341. In some embodiments, user computers 340, 341 can be a mobile device. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In some embodiments, web server 320 can be in data communication through Internet 330 with user computers (e.g., 340, 341). In certain embodiments, user computers 340-341 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, allocation system 310, web server 320, display system 360, shipping buffer system 370, and/or communication system 380 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) allocation system 310, web server 320, display system 360, shipping buffer system 370, and/or communication system 380 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of allocation system 310, web server 320, display system 360, shipping buffer system 370, and/or communication system 380. In a similar manner, the processing module(s) and the memory storage module(s) can be local and/or remote to each other.

In many embodiments, allocation system 310, web server 320, display system 360, shipping buffer system 370, and/or communication system 380 can be configured to communicate with one or more user computers 340 and 341. In some embodiments, user computers 340 and 341 also can be referred to as customer computers. In some embodiments, allocation system 310, web server 320, display system 360, shipping buffer system 370, and/or communication system 380 can communicate or interface (e.g., interact) with one or more customer computers (such as user computers 340 and 341) through a network or internet 330. Internet 330 can be an intranet that is not open to the public. Accordingly, in many embodiments, allocation system 310, web server 320, display system 360, shipping buffer system 370, and/or communication system 380 (and/or the software used by such systems) can refer to a back end of system 300 operated by an operator and/or administrator of system 300, and user computers 340 and 341 (and/or the software used by such systems) can refer to a front end of system 300 used by one or more users 350 and 351, respectively. In some embodiments, users 350 and 351 also can be referred to as customers, in which case, user computers 340 and 341 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, allocation system 310, web server 320, display system 360, shipping buffer system 370, and/or communication system 380 also can be configured to communicate with one or more databases. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between allocation system 310, web server 320, display system 360, shipping buffer system 370, communication system 380, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

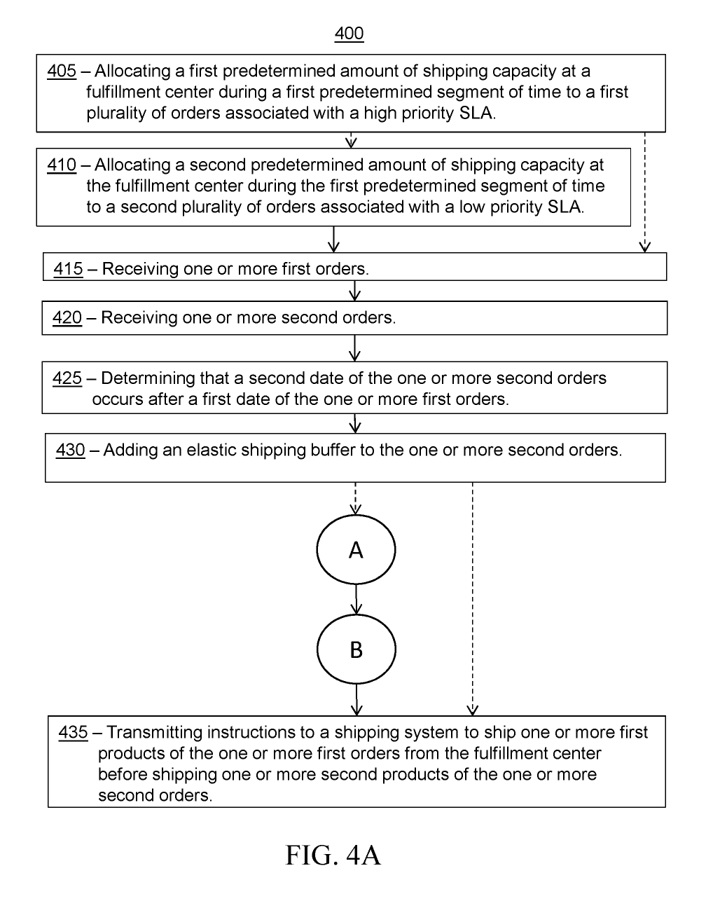

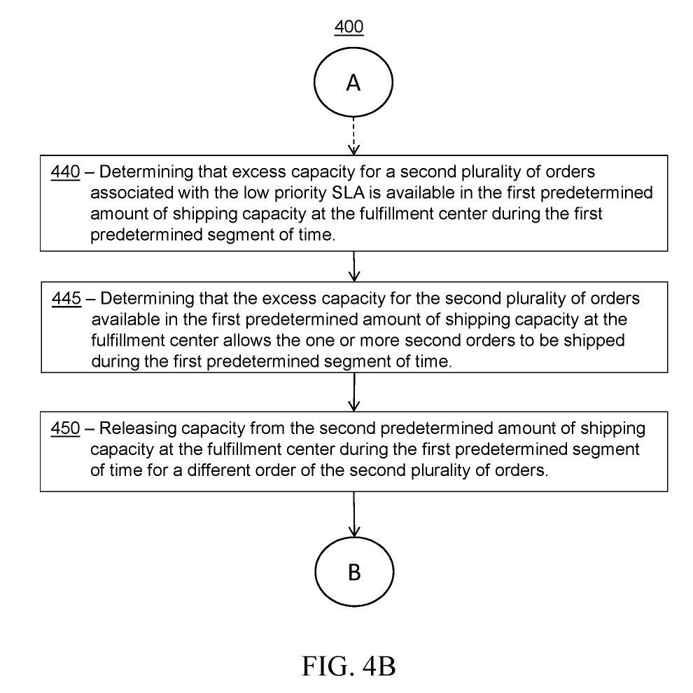

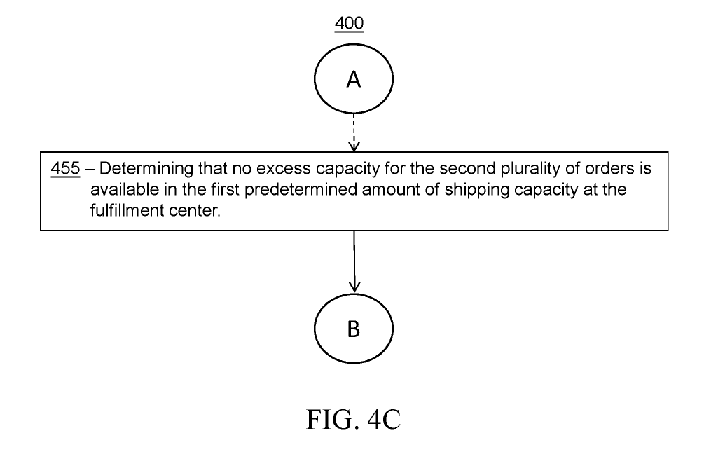

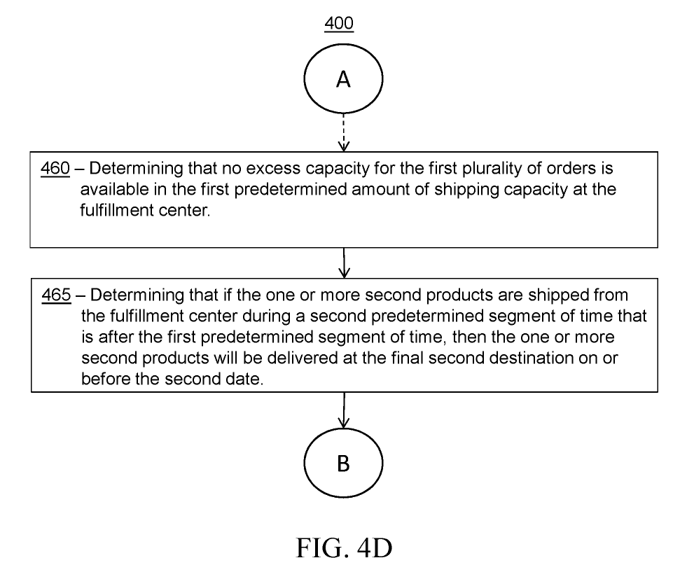

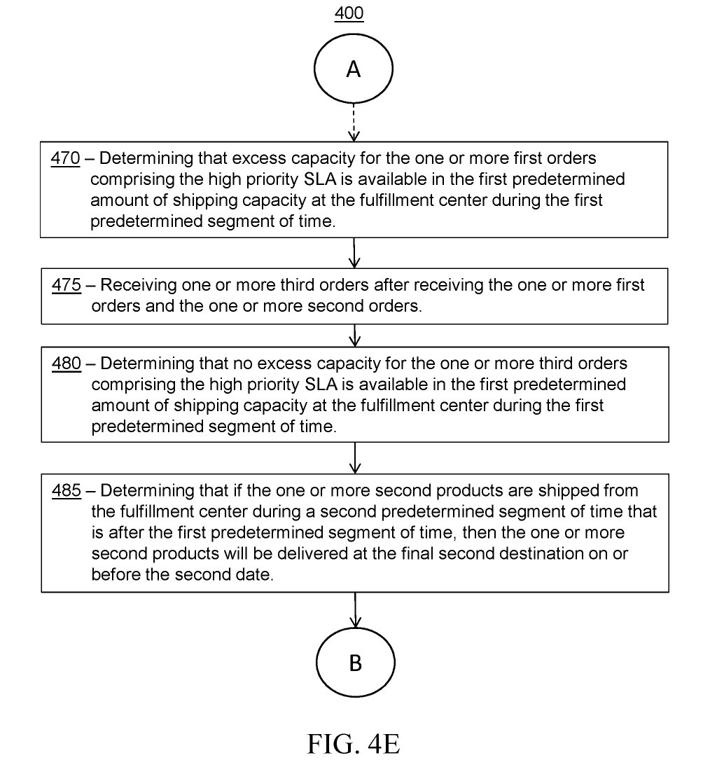

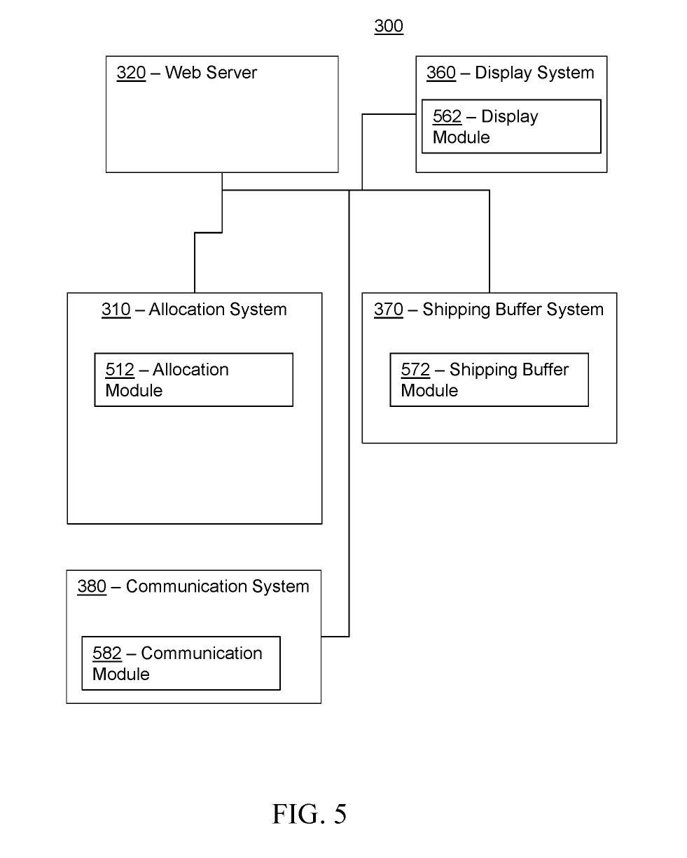

Turning ahead in the drawings, FIGS. 4A-E illustrate flow charts for a method 400, according to some embodiments. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules 512, 562, 572, and/or 582 (FIG. 5). Such non-transitory memory storage modules can be part of a computer system such as allocation system 310, web server 320, display system 360, shipping buffer system 370, and/or communication system 380 (FIGS. 3 & 5). The processing module(s) can be similar or identical to the processing module(s) described above with respect to computer system 100 (FIG. 1).

One or more embodiments of method 400 can be used to fulfill shipment of orders made on the website of an online retailer or at a physical brick and mortar store associated with the online retailer. For example, in some embodiments, customers (or users) can shop on the website associated with the online retailer. The customers shopping on the website can choose from different delivery options with varying delivery or shipping speeds. In some embodiments, the faster shipping speed for the order, the more the customer pays for shipment of the order. When a customer checks out or confirms an order, the customer enters a SLA with the online retailer. The SLA can specify a shipping speed for the order—such as but not limited to 1-day shipping, 2-day shipping, 3 to 5-day shipping, and so on. The faster the shipping speed of the SLA of an order, the higher the priority of the SLA and the order. For example, the SLA of an order by a customer purchasing 1-day shipping can be referred to as a high-priority SLA, and the SLA of an order by a customer agreeing to 3 to 5-day shipping can be referred to as a low-priority SLA.

One or more embodiments of method 400 can be used to prioritize orders made on a website of the online retailer and/or at the physical brick and mortar store associated with the online retailer. Prioritizing the orders can, in some embodiments, create shipping flexibility for one or more fulfillment centers of a retailer to ship orders comprising a slow or low-priority SLA at a later date, while also still meeting the requirements of the low-priority SLA. Thus, the online retailer can prioritize orders comprising high-priority SLAs and faster shipping speeds over orders comprising low-priority SLAs and slower shipping speeds.

As shall be described in greater detail below, in some embodiments, an elastic shipping buffer can be used to prioritize orders associated with a high-priority SLA and orders associated with a low-priority SLA, while still meeting the requirements of both the low-priority SLA and the high-priority SLA. Thus, any elastic shipping buffer set by an administrator for order prioritization should be applied elastically—that is, any delivery promises agreed to by the retailer as part of the SLA should always be kept. In some embodiments, an elastic shipping buffer can be added to an order comprising a low-priority SLA associated with a slower shipping speed such that shipment of the order is delayed by the elastic shipping buffer and the order is shipped later than other orders comprising a high-priority SLA associated with a faster shipping speed. For example, if an administrator sets a buffer of four days for an order comprising a low-priority SLA and associated with a slower shipping speed, system 300 (FIG. 3) can adjust the shipping buffer to ensure that even if shipment of the order comprising the low-priority SLA is delayed, the order will still be delivered according to the terms of the SLA. System 300 can apply the elastic shipping buffer in an elastic manner such that the order delivery date gets pushed by the number of buffer days (four days in this example) or until the products of the order must absolutely be shipped to meet the terms of the SLA.

In some embodiments, application of an elastic shipping buffer to a plurality of orders also can protect faster shipment of orders comprising a high-priority SLA. To accomplish this protection of faster shipment of orders comprising a high-priority SLA, shipping capacity during a predetermined period of time can be reserved for orders comprising a high-priority SLA and/or orders comprising a low-priority SLA to ensure that orders having a high-priority SLA can be shipped sooner. On days when the total number of orders taken for a fulfillment center is higher than what the fulfillment center can ship, the elastic shipping buffer can help create space for high-priority orders. For example, in some embodiments, receiving a high volume of orders comprising a low-priority SLA does not impact shipping speed of orders comprising a high-priority SLA, but receiving a high volume of orders comprising a high-priority SLA can delay shipping and delivery of orders comprising a low-priority SLA.

Turning to FIG. 4A, in some embodiments method 400 can optionally comprise an activity 405 of allocating a predetermined amount of shipping capacity at a fulfillment center during a predetermined segment of time to a plurality of orders associated with a high-priority SLA. Moreover, in some embodiments, method 400 also can optionally comprise an activity 410 (FIG. 4A) of allocating a second predetermined amount of shipping capacity at the fulfillment center during a predetermined segment of time to a plurality of orders associated with a low-priority SLA. As noted above, the high-priority SLA can comprise paid and/or shipping and/or faster shipping speeds than a low-priority SLA, while the low-priority SLA can comprise paid and/or free shipping and/or slower shipping speeds than a high-priority SLA. A predetermined segment of time can comprise an entire day or blocks of hours within a single day, such as but not limited a block of time that is less than 12 hours, a block of time that is from 5 AM to noon, a block of time that is from noon to 6 PM, and/or a block of time that is from 6 PM to midnight. The fulfillment center can comprise a warehouse, a distribution center, a retail store, and the like.

In some embodiments, shipping capacity during a predetermined segment of time can be allocated according to a priority order forecast for a certain day and/or certain time for the certain day. By way of a non-limiting example, a priority order forecast can be used to allocate a shipping capacity of 10,000 high-priority orders for a predetermined segment of time. If the maximum shipping capacity for the fulfillment center is 35,000 orders, and a shipping capacity of 10,000 orders has been allocated to orders comprising high-priority SLAs, 25,000 orders is the maximum capacity that can be used for orders comprising low-priority SLA during that predetermined segment of time. As noted above, however, if more than 10,000 orders comprising a high SLA are received, some or all of the 25,000 capacity for orders comprising a low-priority SLA can be used for the orders comprising a high-priority SLA.

Continuing in FIG. 4A, method 400 also can comprise an activity 415 (FIG. 4A) of receiving one or more first orders. The one or more first orders can comprise orders made by a customer on a website of an online retailer or, alternatively, at a brick and mortar store associated with the online retailer. Each order of the one or more first orders can comprise (1) one or more first products for shipping from a fulfillment center, (2) a final first destination for delivery of the one or more first products of the one or more first orders, and (3) a first SLA that specifies a first date by which the one or more first products will be delivered at the final first destination. In some embodiments, the first SLA of each order of the one or more first orders can comprise the high-priority SLA.

Continuing in FIG. 4A and similar to activity 415, method 400 can further comprise an activity 420 of receiving one or more second orders. Each order of the one or more second orders also can comprise (1) one or more second products for shipping from the fulfillment center, (2) a final second destination for delivery of the one or more second products of the one or more second orders, and (3) a second SLA that specifies a second date by which the one or more second products will be delivered at the final second destination. In some embodiments, the second SLA of each order of the one or more second orders can comprise a low-priority SLA that is lower in shipping priority than the high-priority SLA. In some embodiments, the SLA priorities of the orders in activities can be reversed and/or the sequence of activities 415 and 420 can be reversed. Also, activities 415 and 420 often occur on the same day and/or within 24 hours of each other, but also can occur on different days.

Method 400 can further comprise an activity of retrieving information about the one or more first orders, the one or more second orders, and/or any additional order from a central database associated with the online retailer. In some embodiments, retrieving information can comprise using a distributed network comprising distributed memory architecture to retrieve information about the one or more first orders, the one or more second orders, and/or any additional order. This distributed architecture can reduce the impact on the network and system resources to reduce congestion in bottlenecks while still allowing data to be accessible from a central location. In some embodiments, retrieving information is performed while a user is shopping on a website of the online retailer and before the user purchases one or more products and makes the order. In some embodiments, retrieving information is performed after a user purchases one or more products, and system 300 is retrieving information about the orders for shipping purposes.

Method 400 can further comprise an activity 425 (FIG. 4A) of determining that the second date of the one or more second orders occurs after the first date of the one or more first orders. Thus, in some embodiments, method 400 can comprising an activity of determining that the one or more first orders should be delivered to the final first destination before the one or more second orders need to be delivered to the final second destination.

Method 400 can further comprise an activity 430 (FIG. 4A) of adding an elastic shipping buffer to the one or more second orders. Adding an elastic shipping buffer to the one or more second orders can prevent the one or more second orders from being shipped from the fulfillment center before the one or more first orders. Adding the elastic shipping buffer to the one or more second orders also can simultaneously prevent the one or more second orders from being delivered at the final second destination after the second date of the second SLA even if adding the elastic shipping buffer delays shipment of the products of the one or more second orders from the fulfillment center. In some embodiments, adding the elastic shipping buffer to the one or more second orders, or any orders comprising a low-priority SLA, can comprise setting an amount of shipping buffer days for the one or more second orders. For example, an administrator or system 300 (FIG. 3) can determine that the one or more second orders can comprise four shipping buffer days and still be delivered at the final second destination by the second date, and thus meet the terms of the low-priority SLA of the one or more second orders.

Returning to FIG. 4A, in some embodiments method 400 can further comprise an activity 435 of transmitting instructions to a shipping system to ship one or more first products of the one or more first orders from the fulfillment center before shipping one or more second products of the one or more second orders according to the elastic shipping buffer. Shipment of the one or more first orders and the one or more second orders from the fulfillment center can nonetheless occur on the same day or on different days. In more particular embodiments, transmitting the instructions to the shipping system comprises transmitting instructions to the shipping system to ship the one or more first products from the fulfillment center during the first predetermined segment of time and before shipping the one or more second products from the fulfillment center according to the elastic shipping buffer.

The shipping system can comprise any of a number of shipping systems. For example, the shipping system can comprise a fleet shipping system associated with the online retailer, a third-party shipping and delivery service, or some combination thereof. As such, the shipping system can comprise computer systems similar to the computer systems described in relation to FIGS. 1 and 2, and also one or more shipping vehicles. The one or more shipping vehicles can comprise vans, trucks, motorcycles, bicycles, trains, boats, airplanes, and the like.

In some embodiments, it can be advantageous for system 300 (FIG. 3) to determine whether there is excess capacity for a second plurality of orders associated with the low-priority SLA available in the first predetermined amount of shipping capacity at the fulfillment center. Normally, the first predetermined amount of shipping capacity is reserved for orders associated with a high-priority SLA, and a second predetermined amount of shipping capacity is originally assigned orders associated a low-priority SLA. If, however, system 300 determines that the first predetermined amount of shipping capacity will not be filled by orders associated with the high-priority SLA, system 300 can release at least a portion of the first predetermined amount of shipping capacity to one or more orders associated with the low-priority SLA. If capacity is released from the first predetermined amount of shipping capacity for one or more orders associated with the low-priority SLA, capacity also can be released from a second predetermined amount of shipping capacity to make room for additional orders associated with the low-priority SLA.

Turning to FIG. 4B, then, in some embodiments method 400 can optionally comprise an activity 440 of determining that excess capacity for a second plurality of orders associated with the low-priority SLA is available in the first predetermined amount of shipping capacity at the fulfillment center during the first predetermined segment of time allocated to the first plurality of orders associated with the high-priority SLA. If system 300 (FIG. 3) determines that excess capacity for a second plurality of orders associated with the low-priority SLA is available in the first predetermined amount of shipping capacity at the fulfillment center during the first predetermined segment of time allocated to the first plurality of orders associated with the high-priority SLA, then transmitting the instructions to the shipping system can comprise transmitting instructions to the shipping system to ship the one or more first products from the fulfillment center during the first predetermined segment of time, and also transmitting instructions to the shipping system to ship the one or more second products from the fulfillment center during the first predetermined segment of time according to the elastic shipping buffer.

Returning to FIG. 4B, if the one or more processors determine that the excess capacity for the second plurality of orders is available in the first predetermined amount of shipping capacity at the fulfillment center, method 400 can next optionally comprise an activity 445 of determining that the excess capacity for the second plurality of orders available in the first predetermined amount of shipping capacity at the fulfillment center allows the one or more second orders to be shipped during the first predetermined segment of time. Next, method 400 can optionally comprise an activity 450 (FIG. 4B) of releasing capacity from the second predetermined amount of shipping capacity at the fulfillment center during the first predetermined segment of time for a different order of the second plurality of orders.

In some embodiments, it can be advantageous for system 300 (FIG. 3) to determine whether there is any excess capacity for the second plurality of orders associated with the low-priority SLA available in the first predetermined amount of shipping capacity reserved for orders associated with the high-priority SLA at the fulfillment center. The first predetermined amount of shipping capacity can be reserved for orders associated with a high-priority SLA. If system 300 determines that there is no excess capacity for orders associated with the low-priority SLA in the first predetermined amount of shipping capacity, the orders associated with the low-priority can still be shipped during the first predetermined segment of time if excess orders associated with the high-priority SLA do not exceed the first predetermined amount of shipping capacity. Thus, system 300 can determine that while there is no excess capacity for low-priority SLAs in the shipping capacity allocated to high-priority SLAs, there is also not a high volume of high-priority SLAs that will overflow the shipping capacity allocated to high-priority SLAs and interfere with capacity originally assigned to low-priority SLAs.

Turning ahead in the drawings to FIG. 4C, in some embodiments, then, method 400 can optionally comprise an activity 455 of determining that no excess capacity for the second plurality of orders is available in the first predetermined amount of shipping capacity at the fulfillment center. If system 300 (FIG. 3) determines that no excess capacity for the second plurality of orders is available in the first predetermined amount of shipping capacity at the fulfillment center, then transmitting the instructions to the shipping system can comprise transmitting instructions to the shipping system to ship the one or more first products from the fulfillment center during the first predetermined segment of time, and also transmitting instructions to the shipping system to ship the one or more second products from the fulfillment center during the first predetermined segment of time according to the elastic shipping buffer. Activity 455 can be performed without performing activities 440, 445, and/or 450 in FIG. 4B.

In some embodiments, it can be advantageous for system 300 (FIG. 3) to determine whether there is any excess capacity for one or more orders associated with the high-priority SLA available in the first predetermined amount of shipping capacity during the first predetermined segment of time at the fulfillment center. As noted above, the first predetermined amount of shipping capacity can be reserved for orders associated with a high-priority SLA. If system 300 determines there is no excess capacity for one or more orders associated with the high-priority SLA in the first predetermined amount of shipping capacity at the fulfillment center, system 300 also can determine what orders associated with a low-priority SLA can be bumped from the first predetermined segment of time to a later predetermined segment of time and still meet the shipping requirements of the low-priority SLA. When system 300 finds one or more orders associated with the low-priority SLA that meet this criteria, the system can apply the elastic shipping buffer and bump shipment of the one or more orders associated with the low-priority SLA to a later predetermined segment of time. Thus, if there is no capacity in the shipping capacity allocated to high-priority SLAs and also a high volume of orders comprising high-priority SLAs, system 300 can bump low-priority SLAs to a later segment of time.

Turning ahead in the drawings to FIG. 4D, in some embodiments, then, method 400 can optionally comprise an activity 460 of determining that no excess capacity for the first plurality of orders is available in the first predetermined amount of shipping capacity at the fulfillment center. If system 300 (FIG. 3) determines that no excess capacity for the first plurality of orders is available in the first predetermined amount of shipping capacity at the fulfillment center, method 400 can next optionally comprise an activity 465 (FIG. 4D) of determining that if the one or more second products are shipped from the fulfillment center during a second predetermined segment of time that is after the first predetermined segment of time, then the one or more second products will be delivered at the final second destination on or before the second date. Furthermore, if system 300 (FIG. 3) determines that no excess capacity for the first plurality of orders is available in the first predetermined amount of shipping capacity at the fulfillment center, transmitting the instructions to the shipping system can comprise transmitting instructions to the shipping system to ship the one or more first products from the fulfillment center during the first predetermined segment of time, and also transmitting instructions to the shipping system to ship the one or more second products from the fulfillment center during the second predetermined segment of time that is after the first predetermined segment of time according to the elastic shipping buffer. Activities 460 and/or 465 can be performed without also performing the activities shown in FIG. 4B and 4C.

In some embodiments, it can be advantageous for system 300 (FIG. 3) to determine a newly placed order comprising a high-priority SLA should be prioritized for shipping before a previously placed order with low-priority SLA. In some embodiments, if the shipping capacity allocated to high-priority SLAs is full, prioritization of the new order can be made even if the previously placed low-priority SLA is bumped to a later segment of time for shipping.

Turning ahead in the drawings to FIG. 4E, in some embodiments, then, method 400 can optionally comprise an activity 470 of determining that excess capacity for the one or more first orders comprising the high-priority SLA is available in the first predetermined amount of shipping capacity at the fulfillment center during the first predetermined segment of time. Method 400 can next optionally comprise an activity 475 of receiving one or more third orders after receiving the one or more first orders and the one or more second orders. Each order of the one or more third orders can comprise (1) one or more third products for shipping from the fulfillment center, (2) a final third destination for delivery of the one or more third products of the one or more third orders, and (3) a third, high-priority SLA that specifies the first date by which the one or more third products will be delivered at the final third destination.

Continuing in FIG. 4E, in some embodiments, method 400 can optionally comprise an activity 480 of determining that no excess capacity for the one or more third orders comprising the high-priority SLA is available in the first predetermined amount of shipping capacity at the fulfillment center during the first predetermined segment of time. If system 300 (FIG. 3) determines that no excess capacity for the one or more third orders comprising the high-priority SLA is available in the first predetermined amount of shipping capacity at the fulfillment center during the first predetermined segment of time, method 400 can next optionally comprise an activity 485 (FIG. 4E) of determining that if the one or more second products are shipped from the fulfillment center during a second predetermined segment of time that is after the first predetermined segment of time, then the one or more second products will be delivered at the final second destination on or before the second date. If system 300 (FIG. 3) determines that if the one or more second products are shipped from the fulfillment center during a second predetermined segment of time that is after the first predetermined segment of time, then the one or more second products will be delivered at the final second destination on or before the second date, transmitting the instructions to the shipping system can comprise transmitting instructions to the shipping system to ship the one or more first products from the fulfillment center during the first predetermined segment of time, transmitting instructions to the shipping system to ship the one or more third products from the fulfillment center during the first predetermined segment of time, and also transmitting instructions to the shipping system to ship the one or more second products from the fulfillment center during the second predetermined segment of time according to the elastic shipping buffer.

FIG. 5 illustrates a block diagram of a portion of system 300 comprising allocation system 310, web server 320, display system 360, shipping buffer system 370, and communication system 380, according to the embodiment shown in FIG. 3. Each of allocation system 310, web server 320, display system 360, shipping buffer system 370, and communication system 380, is merely exemplary and not limited to the embodiments presented herein. Each of allocation system 310, web server 320, display system 360, shipping buffer system 370, and/or communication system 380, can be employed in many different embodiments or examples not specifically depicted or described herein. In some embodiments, certain elements or modules of allocation system 310, web server 320, display system 360, shipping buffer system 370, and/or communication system 380, can perform various procedures, processes, and/or acts. In other embodiments, the procedures, processes, and/or acts can be performed by other suitable elements or modules.

In many embodiments, allocation system 310 can comprise non-transitory memory storage module 512. Memory storage module 512 can be referred to as allocation module 512. In many embodiments, allocation module 512 can store computing instructions configured to run on one or more processing modules and perform one or more acts of method 400 (FIGS. 4A-E) (e.g., activity 405 of Allocating a first predetermined amount of shipping capacity at a fulfillment center during a first predetermined segment of time to a first plurality of orders associated with a high-priority SLA (FIG. 4A), activity 410 of allocating a second predetermined amount of shipping capacity at the fulfillment center during the first predetermined segment of time to a second plurality of orders associated with a low-priority SLA (FIG. 4A), and activity 450 of releasing capacity from the second predetermined amount of shipping capacity at the fulfillment center during the first predetermined segment of time for a different order of the second plurality of orders (FIG. 4B)).

In many embodiments, display system 360 can comprise non-transitory memory storage module 562. Memory storage module 562 can be referred to as display module 562. In many embodiments, display module 562 can store computing instructions configured to run on one or more processing modules and perform one or more acts associated with method 400. For example, display system 360 can coordinate display of the one or more first, second, and/or third orders, coordinate display of first and/or second predetermined amounts of shipping capacity, coordinate display of an elastic shipping buffer, and/or coordinate display of shipping instructions for the one or more first, second, and/or third orders.

In many embodiments, shipping buffer system 370 can comprise non-transitory memory storage module 572. Memory storage module 572 can be referred to as shipping buffer module 572. In many embodiments, shipping buffer module 572 can store computing instructions configured to run on one or more processing modules and perform one or more acts of method 400 (FIGS. 4A-E) (e.g., activity 425 of determining that a second date of the one or more second orders occurs after a first date of the one or more first orders (FIG. 4A), activity 430 of adding an elastic shipping buffer to the one or more second orders (FIG. 4A), activity 440 of determining that excess capacity for a second plurality of orders associated with the low-priority SLA is available in the first predetermined amount of shipping capacity at the fulfillment center during the first predetermined segment of time (FIG. 4B), activity 445 of determining that the excess capacity for the second plurality of orders available in the first predetermined amount of shipping capacity at the fulfillment center allows the one or more second orders to be shipped during the first predetermined segment of time (FIG. 4B), activity 455 of determining that no excess capacity for the second plurality of orders is available in the first predetermined amount of shipping capacity at the fulfillment center (FIG. 4C), activity 460 of determining that no excess capacity for the first plurality of orders is available in the first predetermined amount of shipping capacity at the fulfillment center (FIG. 4D), activity 465 of determining that if the one or more second products are shipped from the fulfillment center during a second predetermined segment of time that is after the first predetermined segment of time, then the one or more second products will be delivered at the final second destination on or before the second date (FIG. 4D), activity 470 of determining that excess capacity for the one or more first orders comprising the high-priority SLA is available in the first predetermined amount of shipping capacity at the fulfillment center during the first predetermined segment of time (FIG. 4E), activity 480 of determining that no excess capacity for the one or more third orders comprising the high-priority SLA is available in the first predetermined amount of shipping capacity at the fulfillment center during the first predetermined segment of time (FIG. 4E), and activity 485 of determining that if the one or more second products are shipped from the fulfillment center during a second predetermined segment of time that is after the first predetermined segment of time, then the one or more second products will be delivered at the final second destination on or before the second date (FIG. 4E)).

In many embodiments, communication system 380 can comprise non-transitory memory storage module 582. Memory storage module 582 can be referred to as communication module 582. In many embodiments, communication module 582 can store computing instructions configured to run on one or more processing modules and perform one or more acts of method 400 (FIGS. 4A-E) (e.g., activity 415 of receiving one or more first orders (FIG. 4A), activity 420 of receiving one or more second orders (FIG. 4A), activity 435 of transmitting instructions to a shipping system to ship one or more first products of the one or more first orders from the fulfillment center before shipping one or more second products of the one or more second orders (FIG. 4A), and activity 475 of receiving one or more third orders after receiving the one or more first orders and the one or more second orders (FIG. 4E)).

Although systems and methods for improving outbound shipping capacity have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIGS. 4A-E and 5 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform acts of:
receiving one or more first orders, each order of the one or more first orders comprising (1) one or more first products for shipping from a fulfillment center, (2) a final first destination for delivery of the one or more first products of the one or more first orders, and (3) a first service level agreement (SLA) that specifies a first date by which the one or more first products will be delivered at the final first destination;
receiving one or more second orders, each order of the one or more second orders comprising (1) one or more second products for shipping from the fulfillment center, (2) a final second destination for delivery of the one or more second products of the one or more second orders, and (3) a second SLA that specifies a second date by which the one or more second products will be delivered at the final second destination;
determining that the second date of the one or more second orders occurs after the first date of the one or more first orders;
adding an elastic shipping buffer to the one or more second orders to (1) prevent the one or more second orders from being shipped from the fulfillment center before the one or more first orders and also (2) prevent the one or more second orders from being delivered at the final second destination after the second date of the second SLA; and
transmitting instructions to a shipping system to ship the one or more first products of the one or more first orders from the fulfillment center before shipping the one or more second products of the one or more second orders from the fulfillment center according to the elastic shipping buffer.

2. The system of claim 1, wherein:
the one or more non-transitory storage modules storing the computing instructions are further configured to run on the one or more processing modules and perform an act of allocating a first predetermined amount of shipping capacity at the fulfillment center during a first predetermined segment of time to a first plurality of orders associated with a high-priority SLA;
the first SLA of each order of the one or more first orders comprises the high-priority SLA;
the second SLA of each order of the one or more second orders comprises a low-priority SLA that is lower in shipping priority than the high-priority SLA; and
transmitting the instructions to the shipping system comprises transmitting instructions to the shipping system to ship the one or more first products from the fulfillment center during the first predetermined segment of time and before shipping the one or more second products from the fulfillment center according to the elastic shipping buffer.

3. The system of claim 2, wherein:
the one or more non-transitory storage modules storing the computing instructions are further configured to run on the one or more processing modules and perform acts of:
allocating a second predetermined amount of shipping capacity at the fulfillment center during the first predetermined segment of time to a second plurality of orders associated with the low-priority SLA; and
transmitting the instructions to the shipping system comprises:
transmitting instructions to the shipping system to ship the one or more first products from the fulfillment center during the first predetermined segment of time; and
transmitting instructions to the shipping system to ship the one or more second products from the fulfillment center during the first predetermined segment of time according to the elastic shipping buffer.

4. The system of claim 2, wherein:
the one or more non-transitory storage modules storing the computing instructions are further configured to run on the one or more processing modules and perform acts of:
allocating a second predetermined amount of shipping capacity at the fulfillment center during the first predetermined segment of time to a second plurality of orders associated with the low-priority SLA;
determining that no excess capacity for the first plurality of orders is available in the first predetermined amount of shipping capacity at the fulfillment center; and
determining that if the one or more second products are shipped from the fulfillment center during a second predetermined segment of time that is after the first predetermined segment of time, then the one or more second products will be delivered at the final second destination on or before the second date; and
transmitting the instructions to the shipping system comprises:
transmitting instructions to the shipping system to ship the one or more first products from the fulfillment center during the first predetermined segment of time; and
transmitting instructions to the shipping system to ship the one or more second products from the fulfillment center during the second predetermined segment of time that is after the first predetermined segment of time according to the elastic shipping buffer.

5. The system of claim 2, wherein:
the one or more non-transitory storage modules storing the computing instructions are further configured to run on the one or more processing modules and perform acts of:
allocating a second predetermined amount of shipping capacity at the fulfillment center during the first predetermined segment of time to a second plurality of orders associated with the low-priority SLA;
determining that excess capacity for the one or more first orders comprising the high-priority SLA is available in the first predetermined amount of shipping capacity at the fulfillment center during the first predetermined segment of time;
receiving one or more third orders after receiving the one or more first orders and the one or more second orders, each order of the one or more third orders comprising (1) one or more third products for shipping from the fulfillment center, (2) a final third destination for delivery of the one or more third products of the one or more third orders, and (3) a third SLA that specifies the first date by which the one or more third products will be delivered at the final third destination, wherein the third SLA of each order of the one or more third orders comprises the high-priority SLA;
determining that no excess capacity for the one or more third orders comprising the high-priority SLA is available in the first predetermined amount of shipping capacity at the fulfillment center during the first predetermined segment of time; and
determining that if the one or more second products are shipped from the fulfillment center during a second predetermined segment of time that is after the first predetermined segment of time, then the one or more second products will be delivered at the final second destination on or before the second date; and
transmitting the instructions to the shipping system comprises:
transmitting instructions to the shipping system to ship the one or more first products from the fulfillment center during the first predetermined segment of time;
transmitting instructions to the shipping system to ship the one or more third products from the fulfillment center during the first predetermined segment of time; and
transmitting instructions to the shipping system to ship the one or more second products from the fulfillment center during the second predetermined segment of time according to the elastic shipping buffer.

6. The system of claim 2, wherein the first predetermined segment of time comprises a portion of a day comprising less than 12 hours.

7. The system of claim 2, wherein the high-priority SLA comprises paid shipping and the low-priority SLA comprises free shipping.

8. The system of claim 1, wherein:
the one or more non-transitory storage modules storing the computing instructions are further configured to run on the one or more processing modules and perform acts of:
allocating a first predetermined amount of shipping capacity at the fulfillment center during a first predetermined segment of time to a first plurality of orders associated with a high-priority SLA, wherein the first SLA of the one or more first orders comprises the high-priority SLA and the second SLA of the one or more second orders comprises a low-priority SLA that is lower in shipping priority than the high-priority SLA;
allocating a second predetermined amount of shipping capacity at the fulfillment center during the first predetermined segment of time to the second plurality of orders;
determining if there is no excess capacity for the first plurality of orders available in the first predetermined amount of shipping capacity at the fulfillment center; and
determining that if the one or more second products are shipped from the fulfillment center during a second predetermined segment of time that is after the first predetermined segment of time, then the one or more second products will be delivered at the final second destination on or before the second date if the one or more processors determine that there is no excess capacity for the first plurality of orders available in the first predetermined amount of shipping capacity at the fulfillment center;
the first predetermined segment of time comprises a portion of a day comprising less than 12 hours;
the high-priority SLA comprises paid shipping and the low-priority SLA comprises free shipping; and
transmitting the instructions to the shipping system to ship the one or more first products comprises:
transmitting instructions to the shipping system to ship the one or more first products from the fulfillment center during the first predetermined segment of time before shipping the one or more second products from the fulfillment center during the second predetermined segment of time that is after the first predetermined segment of time according to the elastic shipping buffer if the one or more processing modules determine that there is no excess capacity for the first plurality of orders available in the first predetermined amount of shipping capacity at the fulfillment center.

9. A method comprising:
receiving one or more first orders, each order of the one or more first orders comprising (1) one or more first products for shipping from a fulfillment center, (2) a final first destination for delivery of the one or more first products of the one or more first orders, and (3) a first service level agreement (SLA) that specifies a first date by which the one or more first products will be delivered at the final first destination;
receiving one or more second orders, each order of the one or more second orders comprising (1) one or more second products for shipping from the fulfillment center, (2) a final second destination for delivery of the one or more second products of the one or more second orders, and (3) a second SLA that specifies a second date by which the one or more second products will be delivered at the final second destination;
determining that the second date of the one or more second orders occurs after the first date of the one or more first orders;
adding an elastic shipping buffer to the one or more second orders to (1) prevent the one or more second orders from being shipped from the fulfillment center before the one or more first orders and also (2) prevent the one or more second orders from being delivered at the final second destination after the second date of the second SLA; and
transmitting instructions to a shipping system to ship the one or more first products of the one or more first orders from the fulfillment center before shipping the one or more second products of the one or more second orders from the fulfillment center according to the elastic shipping buffer.

10. The method of claim 9, wherein:
the method further comprises allocating a first predetermined amount of shipping capacity at the fulfillment center during a first predetermined segment of time to a first plurality of orders associated with a high-priority SLA;
the first SLA of each order of the one or more first orders comprises the high-priority SLA;
the second SLA of each order of the one or more second orders comprises a low-priority SLA that is lower in shipping priority than the high-priority SLA; and
transmitting the instructions to the shipping system comprises transmitting instructions to the shipping system to ship the one or more first products from the fulfillment center during the first predetermined segment of time and before shipping the one or more second products from the fulfillment center according to the elastic shipping buffer.

11. The method of claim 10, wherein:
the method further comprises:
allocating a second predetermined amount of shipping capacity at the fulfillment center during the first predetermined segment of time to a second plurality of orders associated with the low-priority SLA; and
transmitting the instructions to the shipping system comprises:
transmitting instructions to the shipping system to ship the one or more first products from the fulfillment center during the first predetermined segment of time; and
transmitting instructions to the shipping system to ship the one or more second products from the fulfillment center during the first predetermined segment of time according to the elastic shipping buffer.

12. The method of claim 10, wherein:
the method further comprises:
allocating a second predetermined amount of shipping capacity at the fulfillment center during the first predetermined segment of time to a second plurality of orders associated with the low-priority SLA;
determining that no excess capacity for the first plurality of orders is available in the first predetermined amount of shipping capacity at the fulfillment center; and
determining that if the one or more second products are shipped from the fulfillment center during a second predetermined segment of time that is after the first predetermined segment of time, then the one or more second products will be delivered at the final second destination on or before the second date; and
transmitting the instructions to the shipping system comprises:
transmitting instructions to the shipping system to ship the one or more first products from the fulfillment center during the first predetermined segment of time; and
transmitting instructions to the shipping system to ship the one or more second products from the fulfillment center during the second predetermined segment of time that is after the first predetermined segment of time according to the elastic shipping buffer.

13. The method of claim 10, wherein:
the method further comprises:
allocating a second predetermined amount of shipping capacity at the fulfillment center during the first predetermined segment of time to a second plurality of orders associated with the low-priority SLA;
determining that excess capacity for the one or more first orders comprising the high-priority SLA is available in the first predetermined amount of shipping capacity at the fulfillment center during the first predetermined segment of time;
receiving one or more third orders after receiving the one or more first orders and the one or more second orders, each order of the one or more third orders comprising (1) one or more third products for shipping from the fulfillment center, (2) a final third destination for delivery of the one or more third products of the one or more third orders, and (3) a third SLA that specifies the first date by which the one or more third products will be delivered at the final third destination, wherein the third SLA of each order of the one or more third orders comprises the high-priority SLA;
determining that no excess capacity for the one or more third orders comprising the high-priority SLA is available in the first predetermined amount of shipping capacity at the fulfillment center during the first predetermined segment of time; and
determining that if the one or more second products are shipped from the fulfillment center during a second predetermined segment of time that is after the first predetermined segment of time, then the one or more second products will be delivered at the final second destination on or before the second date; and
transmitting the instructions to the shipping system comprises:
transmitting instructions to the shipping system to ship the one or more first products from the fulfillment center during the first predetermined segment of time;
transmitting instructions to the shipping system to ship the one or more third products from the fulfillment center during the first predetermined segment of time; and
transmitting instructions to the shipping system to ship the one or more second products from the fulfillment center during the second predetermined segment of time according to the elastic shipping buffer.

14. The method of claim 10, wherein the first predetermined segment of time comprises a portion of a day comprising less than 12 hours.

15. The method of claim 10, wherein the high-priority SLA comprises paid shipping and the low-priority SLA comprises free shipping.

16. The method of claim 9, wherein:
the method further comprises:
allocating a first predetermined amount of shipping capacity at the fulfillment center during a first predetermined segment of time to a first plurality of orders associated with a high-priority SLA, wherein the first SLA of the one or more first orders comprises the high-priority SLA and the second SLA of the one or more second orders comprises a low-priority SLA that is lower in shipping priority than the high-priority SLA;
allocating a second predetermined amount of shipping capacity at the fulfillment center during the first predetermined segment of time to the second plurality of orders;
determining if there is no excess capacity for the first plurality of orders available in the first predetermined amount of shipping capacity at the fulfillment center; and
determining that if the one or more second products are shipped from the fulfillment center during a second predetermined segment of time that is after the first predetermined segment of time, then the one or more second products will be delivered at the final second destination on or before the second date if the one or more processors determine that there is no excess capacity for the first plurality of orders available in the first predetermined amount of shipping capacity at the fulfillment center;
the first predetermined segment of time comprises a portion of a day comprising less than 12 hours;
the high-priority SLA comprises paid shipping and the low-priority SLA comprises free shipping; and
transmitting the instructions to the shipping system to ship the one or more first products comprises:
transmitting instructions to the shipping system to ship the one or more first products from the fulfillment center during the first predetermined segment of time before shipping the one or more second products from the fulfillment center during the second predetermined segment of time that is after the first predetermined segment of time according to the elastic shipping buffer if the one or more processing modules determine that there is no excess capacity for the first plurality of orders available in the first predetermined amount of shipping capacity at the fulfillment center.
